(19) United States
(12) Patent Application Publication
(10) Pub. No.: US 2023/0001495 A1
(43) Pub. Date: Jan. 5, 2023

(54) Dust Management Assembly For a Power Tool

(71) Applicant: Robert Bosch GmbH, Stuttgart (DE)

(72) Inventor: Andrew Frolov, Glenview, IL (US)

(21) Appl. No.: 17/363,369

(22) Filed: Jun. 30, 2021

(51) Int. Cl. B23D 59/00; B23D 45/06

(52) U.S. Cl. CPC B23D 59/006; B23D 45/061

(57) ABSTRACT

A power tool such as a table saw includes a cutting blade, a motor that drives the blade, and a dust management assembly for collecting cutting debris. The position and angle of the blade can be adjusted relative to a table top of the saw. The dust management assembly is disposed below the table top in such a way so as to change positions in concert with the blade, and includes a blade cover that surrounds a portion of the blade; a dust shield that is pivotably connected to the table top in such a way that an inner surface of the dust shield faces toward an outer wall of the blade cover; and a dust port that is detachably connected to the blade cover and is configured collect debris generated by a cutting action of the blade.

### BACKGROUND

Power tools having a rotatable cutting element such as table saws, dados, sanders, grinders, and shapers, may, during operation, generate dust, chips and other debris as byproducts. These byproducts may accumulate within the power tool and may eventually compromise operation of the mechanical components of the power tool. In addition, these by products may escape from the power tool and contaminate the work environment with debris. It is desirable to reduce dust pollution from such power tools.

### SUMMARY

In some aspects, a power tool may include a table top that defines a work surface, and a blade that is mounted near the work surface so as to cut a work piece that is supported on the work surface. For example, in the example in which the power tool is a table saw, the blade may protrude through the work surface and be actuated by a motor assembly that is disposed below the work surface. A dust management assembly provides an enclosure that is mounted to the motor assembly, collects dust and debris generated during cutting operations of the power tool, and directs the dust and debris away from the blade while avoiding pollution of the tool environment.

The dust management assembly includes a blade cover that surrounds a portion of the blade, a dust port that is detachably connected to an open lower end of the blade cover, and a dust shield that cooperates with the blade cover to direct cutting debris to the dust port. The blade cover, dust shield and dust port provide the enclosure which surrounds portions of the blade below the work surface. The dust management assembly is shaped and dimensioned to have close proximity to the blade and to minimize volume of the chamber around the lower portion of the blade.

In particular, the dust management assembly forms a channel around the blade and includes a declining, curved bottom or floor that directs debris to the dust port and provides improved evacuation of debris through the dust port. By this configuration, the enclosure has a small volume and good air flow that is generated by the blade rotation and includes additional air flow exhausted from the motor assembly. The combination of small volume and good air flow results in efficient and reliable evacuation of dust from the enclosure. Since the dust management assembly is mounted to the motor assembly, the dust management assembly moves with the blade between high and low blade positions.

A further advantage of providing a small enclosure is that the dust management assembly uses less materials and is lighter in weight than some known dust management devices.

The dust management assembly is supported on the motor assembly, and therefore moves with the motor assembly and blade from side to side along with any bevel angle adjustment, and up and down along with any blade height adjustment.

The dust port is selectively detachable from the blade cover, which allows for access to the interior of the enclosure and simplifies cleaning.

The dust shield overlies openings between the blade cover and the table top, preventing access to the blade and ensuring closure of the enclosure to minimize dust pollution in the environment of the table saw. This arrangement is particularly advantageous for power tools that are cabinet-free and instead are supported by legs or other supports that do not fully enclose the space below the work surface.

In some aspects, a power tool includes a table top having a work surface disposed on a first side of the table top, and a table top second surface disposed on a second side of the table top, the first and second sides being on opposite sides of the table top. The table top has a blade opening that extends between the work surface and the table top second surface. The power tool includes a rigid undercarriage that is supported on the table top second surface, and a motor assembly that includes a motor and is supported on the undercarriage in such a way that the motor assembly is movable, relative to the undercarriage, between a first position and a second position. The power tool includes a blade, which is driven by the motor to rotate about a rotational axis. The blade extends through the blade opening. In addition, the power tool includes a dust management assembly that is secured to, and moves in concert with, the motor assembly. The dust management assembly includes a blade cover that is fixed to the motor assembly and surrounds a portion of the blade that is disposed on the second side of the table top, a dust shield that is pivotably connected to the table top second surface in such a way that an inner surface of the dust shield faces toward an outer wall of the blade cover, and a dust port that is detachably connected to the blade cover and is configured collect debris generated by a cutting action of the blade.

In some embodiments, the motor assembly and the dust management assembly are disposed on opposite sides of the undercarriage.

In some embodiments, the blade extends through the blade opening in such a way that a first blade surface faces toward a first portion of the blade opening and a second blade surface faces toward a second portion of the blade opening. An edge of the dust shield is aligned with the first portion of the blade opening, and an edge of an inner wall of the blade cover is aligned with the second portion of the blade opening.

In some embodiments, the power tool is cabinet-free. In addition, the dust management assembly surrounds portions of the blade that protrude from the blade opening on the second side of the table top, whereby the dust management assembly serves as a barrier that prevents access to the blade from the second side of the table top.

In some embodiments, the undercarriage extends from the table top second surface and has an undercarriage through opening. A bracket connects the dust management assembly to the motor assembly, and the bracket extends through the undercarriage through opening.

In some embodiments, the dust port is movable relative to the blade cover within a plane that is parallel to the work surface.

In some embodiments, the dust shield is formed of cloth.

In some embodiments, the blade cover includes an inner wall that is disposed between the blade and the undercarriage, an open blade cover first end that adjoins the inner wall and faces toward the table top second surface, and an open blade cover second end that adjoins the inner wall and is opposed to the blade cover first end. The dust shield is disposed on an opposed side of the blade relative to the blade cover inner wall, and is movable relative to the blade cover. In addition, the dust port is detachably connected to the blade cover second end.

In some embodiments, the dust shield is spring-biased toward the blade cover.

In some embodiments, the dust port includes a tubular portion and a trough portion that protrudes from one end of the tubular portion. The trough portion includes a first pair of parallel edges that extend in parallel to a longitudinal axis of the tubular portion, and each edge of the first pair of parallel edges is configured to provide one of a rail or a groove. The blade cover second end includes a second pair of parallel edges, and each edge of the second pair of parallel edges is configured to provide the other of the rail or the groove. In addition, the first pair of parallel edges are configured to engage with, and translate relative to, the second pair of parallel edges.

In some embodiments, the blade cover comprises an inner wall disposed between the blade and the undercarriage, the inner wall being parallel to a first surface of the blade, and an outer wall disposed on a side of the blade that is opposite the undercarriage. The outer wall is angled relative to the first surface of the blade.

In some embodiments, the blade comprises a curved periphery, and the blade cover includes a first side wall disposed on a side of the blade corresponding to a cutting edge of the blade. The first side wall extends between the inner wall and the outer wall. The blade cover includes a second side wall that extends between the inner wall and the outer wall, the second side wall being disposed on an opposed side of the blade relative to the first side wall. The second sidewall has a curved portion that is shaped to correspond to the curved periphery of the blade.

In some embodiments, the blade cover comprises a wall that encircles a portion of the blade, the wall including an open first end that faces toward the table top second surface, and an open second end that is opposed to the first end and forms a connection with the dust port. When viewed in a direction perpendicular to the rotational axis of the blade, a dimension of the first end is greater than a dimension of the second end.

In some embodiments, the dust shield overlies a gap that is disposed between the blade cover and the table top second surface.

In some embodiments, the dust management assembly forms an enclosure around the blade and includes a declining curved surface that directs debris to the dust port.

In some aspects, a power tool includes a table top. The table top includes a work surface that defines a first side of the table top, and a table top second surface that defines a second side of the table top. The first and second sides are on opposite sides of the table top. In addition, the table top includes a blade opening that extends between the work surface and the table top second surface. The power tool includes a rigid undercarriage that is supported on the table top second surface, and a motor assembly that includes a motor and is supported on the undercarriage in such a way that the motor assembly is movable relative to the undercarriage between a first position and a second position. The power tool includes a blade, which is driven by the motor to rotate about a rotational axis. The blade extends through the blade opening. The power tool includes a dust management assembly that is disposed on the opposed side of the undercarriage relative to the motor assembly. The dust management assembly includes a blade cover that is secured to the motor assembly and a dust port. The blade cover includes a sidewall that encircles the blade whereby a portion of the sidewall is disposed between the blade and the undercarriage. The sidewall defines an open blade cover first end that faces toward the table top second surface, and an open blade cover second end that is opposed to the blade cover first end. The dust port is detachably connected to the blade cover second end. The dust port includes a U-shaped trough portion that is configured to be connected to the blade cover, and a tubular portion that protrudes from one end of the trough portion. The trough portion includes a first pair of parallel edges that extend in parallel to a longitudinal axis of the curved portion, and each edge of the first pair of parallel edges is configured to provide one of a rail or a groove. The blade cover second end comprises a second pair of parallel edges, each edge of the second pair of parallel edges is configured to the other of the rail or the groove. In addition, the first pair of parallel edges are configured to engage with, and translate relative to, the second pair of parallel edges.

In some embodiments, the dust management assembly comprises a dust shield that is pivotably connected to the table top second surface in such a way that an inner surface of the dust shield faces toward an outer surface of the sidewall of the blade cover.

In some embodiments, the blade cover sidewall includes an inner wall that is disposed between the blade and the undercarriage, the dust shield is disposed on an opposed side of the blade relative to the blade cover inner wall, the dust shield is movable relative to the blade cover, and the dust shield is spring-biased toward the blade cover.

In some embodiments, the blade cover sidewall includes an inner wall disposed between the blade and the undercarriage. The inner wall is parallel to a first surface of the blade. The blade cover sidewall includes an outer wall disposed on a side of the blade that is opposite the undercarriage. The outer wall is angled relative to the first surface of the blade.

In some embodiments, the dust management assembly forms an enclosure around the blade and includes a declining curved surface that directs debris to the dust port.

### BRIEF DESCRIPTION OF THE DRAWINGS

FIG. 1 is a rear perspective view of a power tool including a dust management assembly.

FIG. 2 is rear perspective view of the power tool of FIG. 1.

FIG. 3 is rear perspective view of the power tool of FIG. 1 shown with most ancillary structures omitted to permit visualization of the dust management assembly, and including the undercarriage and motor assembly.

FIG. 4 is rear perspective view of the power tool of FIG. 1 shown with most ancillary structures omitted to permit visualization of the dust management assembly, and including the undercarriage and motor assembly.

FIG. 5 is a schematic view illustrating the saw blade in a first position relative to the table top.

FIG. 6 is a schematic view illustrating the saw blade in a second position relative to the table top.

FIG. 7 is a cross-sectional view of the power tool as seen along line 7-7 of FIG. 4.

FIG. 8 is a cross-sectional view of the power tool as seen along line 8-8 of FIG. 4.

FIG. 9 is rear perspective view of the power tool of FIG. 1 shown with most ancillary structures including the undercarriage and motor assembly omitted to permit visualization of the dust management assembly.

FIG. 10 is rear perspective view of the power tool of FIG. 1 shown with most ancillary structures including the undercarriage and motor assembly omitted to permit visualization of the dust management assembly.

FIG. 11 is a rear perspective view of the dust management assembly.

FIG. 12 is a rear perspective view of the dust management assembly.

FIG. 13 is a front perspective view of the dust management assembly.

FIG. 14 is a cross-sectional view of the dust management assembly as seen along line 14-14 of FIG. 13.

FIG. 15 is an exploded view of the dust management assembly and cover plate.

FIG. 16 is a rear perspective view of the blade cover.

FIG. 17 is a front perspective view of the blade cover.

FIG. 18 is a front perspective view of the blade cover.

FIG. 19 is a rear perspective view of the blade cover.

FIG. 20 is a rear perspective view of the dust shield.

FIG. 21 is a rear perspective view of the dust shield.

FIG. 22 is a rear perspective view of the dust port.

FIG. 23 is a front perspective view of the dust port.

FIG. 24 is a schematic side view of the power tool shown with most ancillary structures omitted to permit visualization of the dust management assembly, and including the undercarriage and motor assembly, illustrating an alternative embodiment dust shield.

### DETAILED DESCRIPTION

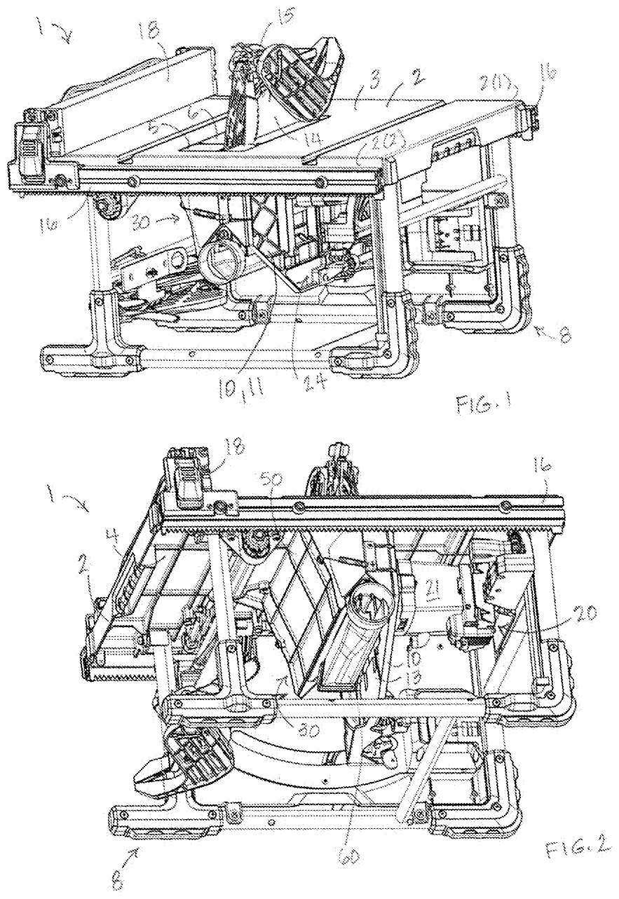

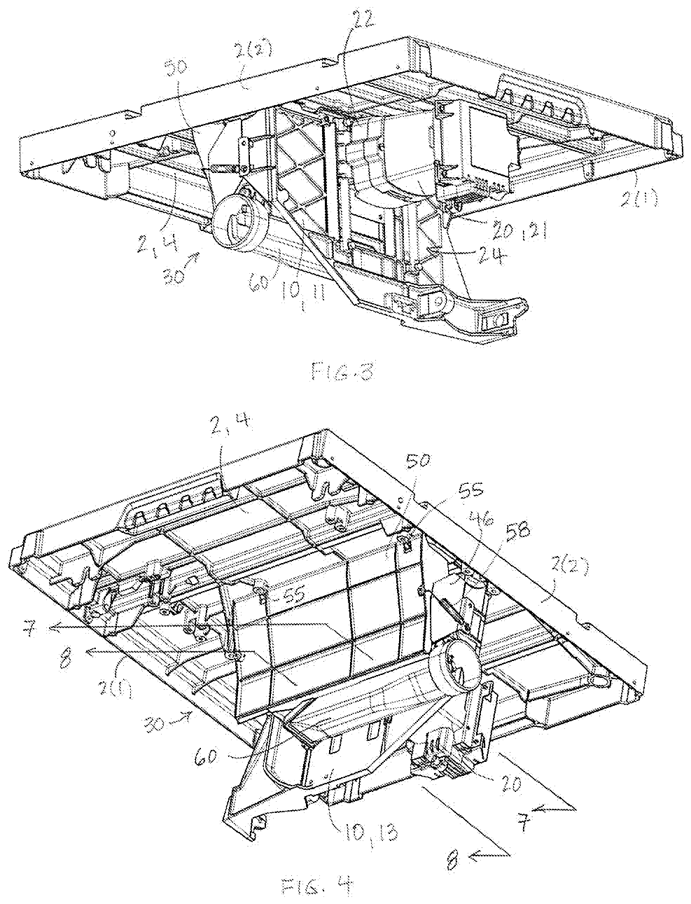

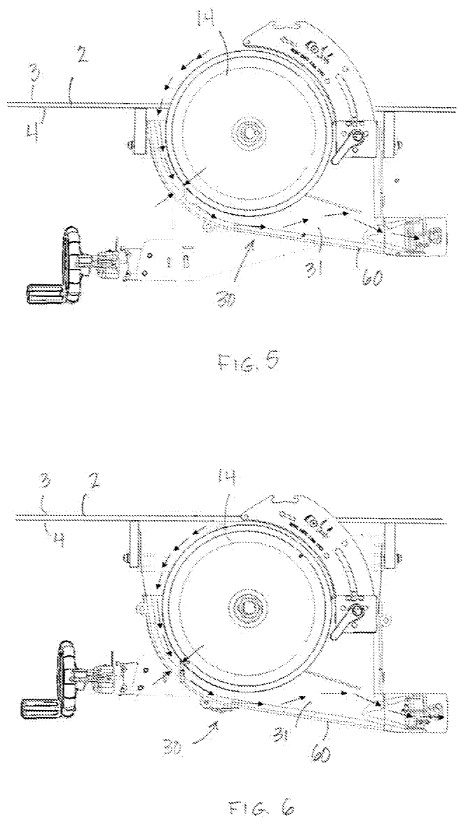

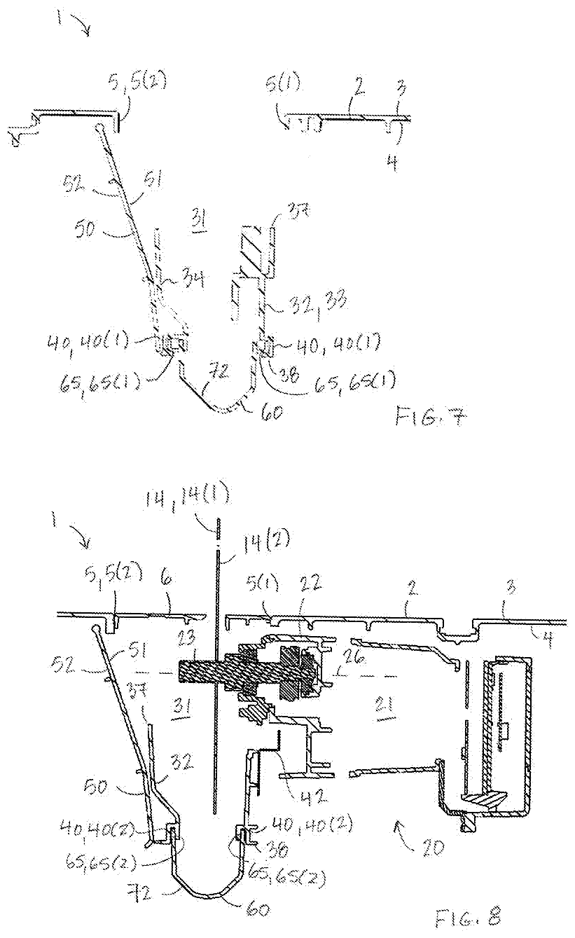

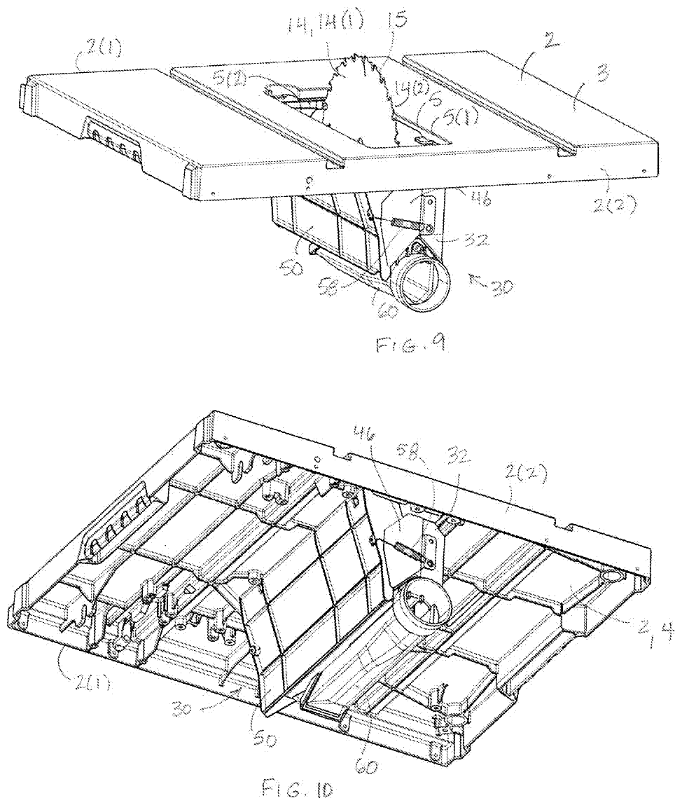

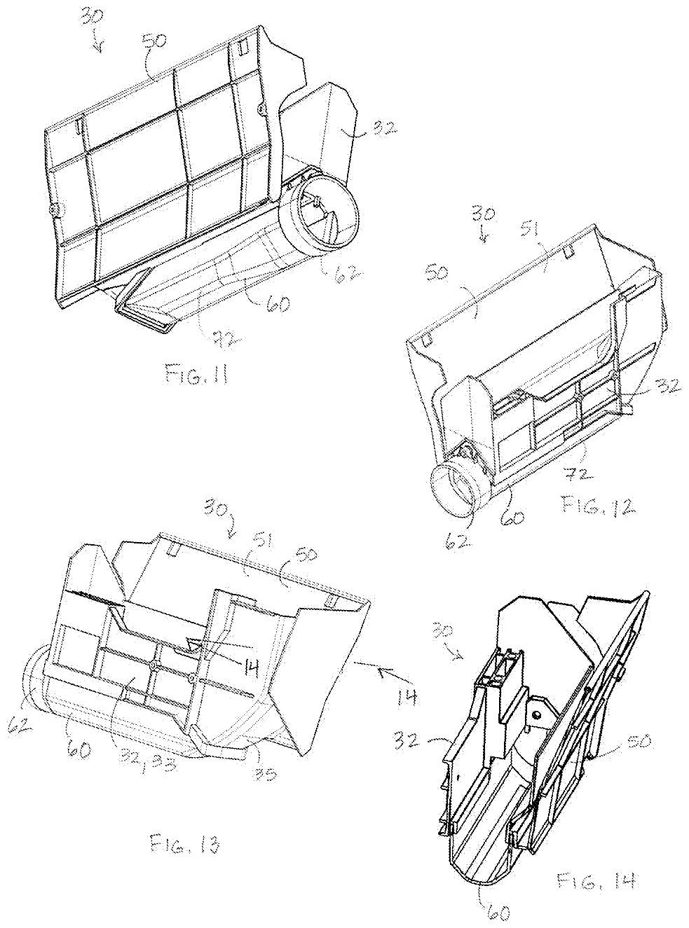

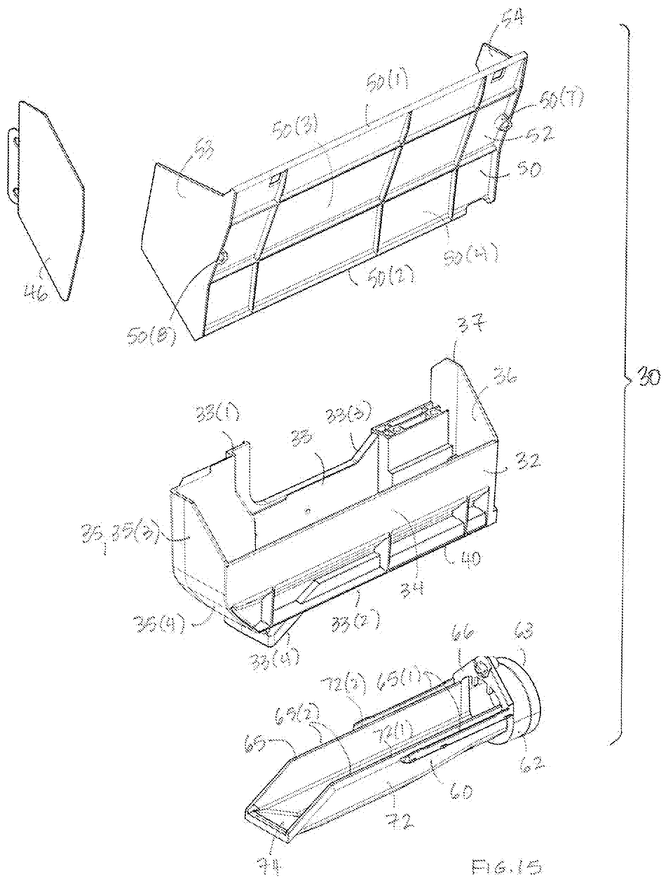

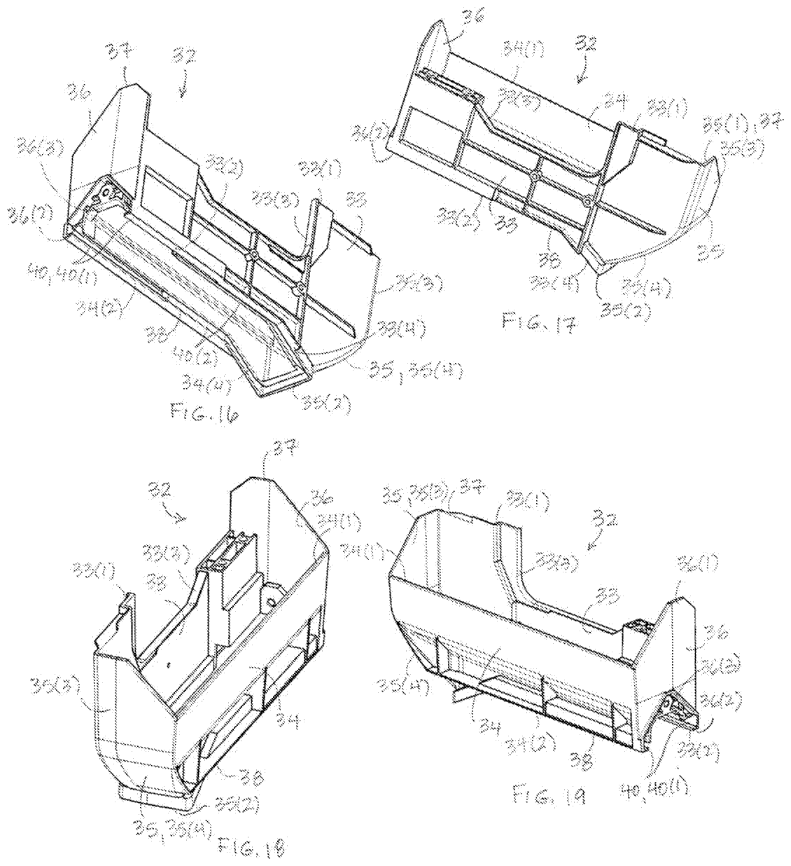

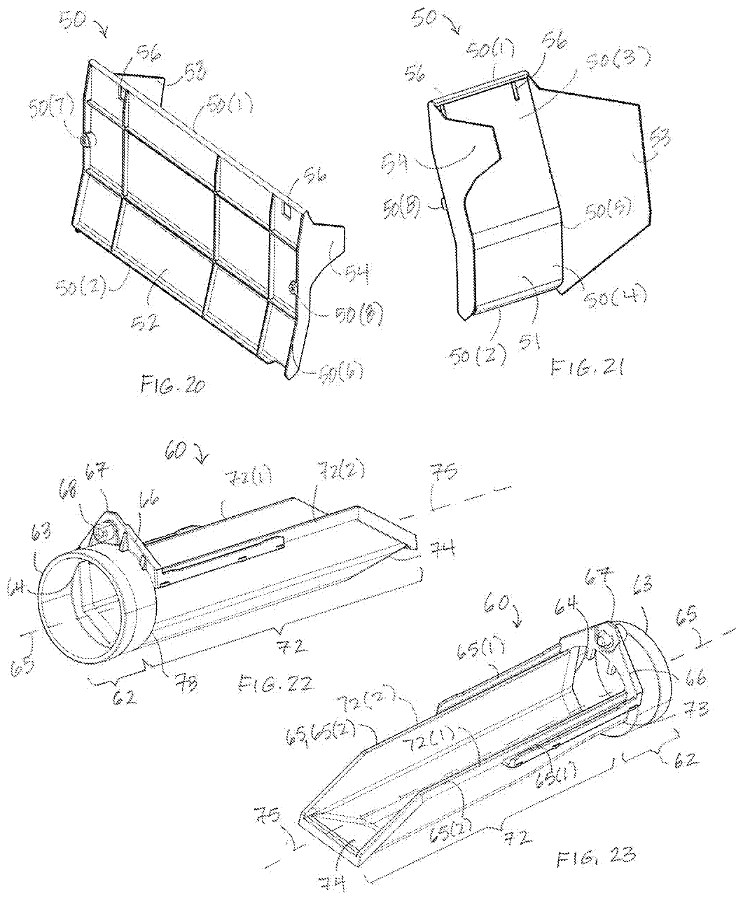

Referring to FIGS. 1-8, a power tool such as a table saw 1 may include a table top 2 and a blade 14 that extends through a blade opening 5 in the table top. One side of the table top 2 defines a work surface 3 on which a workpiece (not shown) is supported. The opposed side of the table top 2 is referred to as the table top second surface 4. In the orientation of the table saw 1 shown in FIG. 1, the table top second surface 4 is below the table top 2. References herein to relative direction such as above, below, upper, lower, top, bottom, front, rear and the like are made for purposes of description with respect to the orientation of the table saw 1 as shown in FIG. 1, and are not limiting. The table saw 1 includes a rigid undercarriage 10 that protrudes from the table top second surface 4. A motor assembly 20 is supported on a first side 11 of the undercarriage 10 by a motor mounting assembly 24. The motor assembly 20 includes a motor 21 and a gearbox 22 that is connected to and modifies the output of the motor 21. An output shaft 23 of the gearbox 22 drives the blade 14 to rotate about a rotational axis 26. The output shaft 23 extends through an opening in the undercarriage 10, whereby the blade 14 is disposed on a second, opposed side 13 of the undercarriage 10 that is opposed to the motor assembly 20. The blade 14 is supported relative to the table top 2 by the motor assembly 20. The motor assembly 20 is mounted to the undercarriage first side 11 in such a way that the blade 14 is configured to move between a first, raised position (FIG. 5) and a second, lowered position (FIG. 6), and to bevel with respect to the work surface 3. In the illustrated embodiment, the table top 2 does not include a cabinet, and instead is supported via an open support structure that includes a set of legs generally referenced by the reference numeral 8. The table top 2 may include fence rails 16 that extend along opposed front and rear edges of the work surface 3, and an adjustable fence 18 that is slideably mounted to the rails 16. An insert 6 may be disposed in the blade opening 5 so as to closely surround the blade 14. The table saw 1 includes other ancillary structures, mechanisms and assemblies which are known in the art and which allow for power supply, adjustment of blade position, adjustment of rail position, storage of accessories, etcetera, and provide safety features. In addition, the table saw 1 includes a dust management assembly 30 that encloses a portion of the blade 14, collects dust and debris generated during cutting operations of the power tool, and directs the dust and debris away from the blade 14 during operation of the table saw 1, as will be described in detail below.

In the example in which the power tool is the table saw 1, the blade 14 is a rigid, thin plate having a circular profile, with cutting teeth that extend along the curved peripheral edge of the plate. The peripheral edge including the cutting teeth will be referred to herein as the cutting edge 15. The blade 14 extends through the blade opening 5 of the table top 2 in such a way that a first blade surface 14(1) faces away from the undercarriage 10. In addition the first blade surface 14(1) faces away from, and is parallel to, a first portion 5(1) of the blade opening 5. A second blade surface 14(2) faces toward the undercarriage 10. The second blade surface 14(2) faces away from, and is parallel to, a second portion 5(2) of the blade opening 5. In the illustrated embodiment, the blade 14 is supported relative to the motor assembly 20 in such a way that the first and second blade surfaces 14(1), 14(2) extend in a direction perpendicular to the rotational axis 26, and the motor assembly 20 is supported on the undercarriage 10 in such a way that the first and second portions 5(1), 5(2) of the blade opening 5 extend between front 2(1) and rear 2(2) sides of the table top 2.

Referring to FIGS. 7-15, the dust management assembly 30 is a multi-part housing that includes a blade cover 32, a dust shield 50 and a dust port 60. The blade cover 32 is fixed to the motor assembly 20 and surrounds a portion of the blade 14 that is disposed below the table top 2. The dust shield 50 is pivotably connected to the table top second surface 4 in such a way that an inner surface 51 of the dust shield 50 faces toward and abuts an outer wall 34 of the blade cover 32. In addition, the dust port 60 is detachably connected a lower end of the blade cover 32, and is configured collect debris generated by a cutting action of the blade 14. The blade cover 32, the dust shield 50 and the dust port 60 cooperate to enclose the portion of the blade 14 that is disposed below the table top 2, whereby the dust management assembly 30 serves as a barrier that prevents access to the blade from the second side of the table top 2. In addition, the dust management assembly 30 is shaped and dimensioned to have close proximity to the blade 14 and to minimize volume of the enclosure 31 around the lower portion of the blade 14. Due the shape of the resulting enclosure 31, and air flow generated due to blade rotation in the enclosure 31, the debris is contained in the enclosure 31 and efficiently discharged from the dust port 60.

Referring to FIGS. 7-8 and 16-19, the blade cover 32 is a generally tubular structure having four sides 33, 34, 35, 36 and opposed open ends 37, 38. More particularly, the blade cover 32 includes an inner wall 33, and outer wall 34, a front wall 35 and a rear wall 36. The inner wall 33 is disposed between the blade 14 and the undercarriage 10, and is perpendicular to the rotational axis 26. The outer wall 34 is disposed on an opposed side of the blade 14 relative to the inner wall 33. The front wall 35 is disposed between the blade 14 and a front side 2(1) of the table top 2, and extends between the inner and outer walls 33, 34 on the front side of the blade 14. Similarly, the rear wall 36 is disposed between the blade 14 and a rear side 2(2) of the table top 2, and extends between the inner and outer walls 33, 34 on the rear side of the blade 14. The first end 37 of the blade cover 32 is open and faces toward the table top second surface 4, while the second end 38 of the blade cover is open and is configured to be connected to the dust port 60, as discussed further below.

The inner wall 33 of the blade cover 32 is generally parallel to the undercarriage 10, and is aligned with the first portion 5(1) of the blade opening 5. By this configuration, the upper edge 33(1) and the lower edge 33(2) of the inner wall 33 are aligned with the first portion 5(1) of the blade opening 5. The inner wall upper edge 33(1) includes a cut out 33(3) to accommodate the output shaft of the gearbox 22. A bracket 42 (FIG. 8) is fixed to an outer surface (e.g., an undercarriage-facing surface) of the inner wall 33. The bracket 42 is used to secure the blade cover 32 to the gear box 22 of the motor assembly 20. In particular, the bracket 42 extends through the undercarriage opening. In addition, one end of the bracket 42 is fixed to the blade cover inner wall 33, and an opposed end of the bracket 42 is fixed to the gear box 22. As a result, the blade cover 32 moves in concert with the motor assembly 20 and blade 14.

The outer wall 34 of the blade cover 32 has a height dimension that is less than a height dimension of the inner wall 33, where the height dimension corresponds to a dimension in a direction perpendicular to the table top second surface 4. As a result, the outer wall 34 is configured to overlie the lowermost portion of the blade 14. For example, the height dimension of the outer wall 34 is in a range of 30 percent to 75 percent of the height dimension of the inner wall 33. The respective lower edges 33(2), 34(2) of the inner and outer walls 33, 34 each have approximately the same spacing relative to the table top second surface 4. By this configuration, a spacing between the outer wall upper edge 34(1) and the table top second surface 4 is much greater than the corresponding spacing of the inner wall upper edge 33(1), whereby a portion of the outward-facing surface of the blade 14 is exposed by the blade cover 32. This portion of the blade 14 is enclosed via the dust shield 50, as discussed below. In addition, the outer wall 34 is slightly angled relative to the undercarriage 10, whereby a distance between the inner wall 33 and an upper edge 34(1) of the outer wall 34 is slightly greater than a distance between the inner wall 33 and a lower edge 34(2) of the outer wall 34.

The rear wall 36 of the blade cover 32 is generally planar, and a lower edge 36(2) includes a cut out 36(3) that is shaped and dimensioned to receive a portion of the dust port 60 therein.

The front wall 35 of the blade cover 32 has an upper portion 35(3) that is planar and generally parallel to the rear wall 36, and a lower portion 35(4) that is curved to correspond to the curved shaped of the blade 14. As a result, a lower edge 35(2) of the front wall 35 is closer to the rear wall 36 than an upper edge 35(1) of the front wall 35. In addition, the spacing of the lower edge 35(2) of the front wall 35 from the table top second surface 4 is greater than the spacing of the lower edge 36(2) of the rear wall 36 from the table top second surface 4. To accommodate this difference in spacing, the lower edges 33(2), 34(2) of the inner and outer walls 33, 34 each include an angled portion 33(4), 34(4) that adjoins the front wall lower edge 35(2).

The blade cover 32 forms a sliding, detachable connection with the dust port 60. To this end, the respective lower edges 33(2), 34(2) of the inner and outer walls 33, 34 are parallel to each other and are configured to form a slidable engagement with respect to corresponding parallel upper edges 72(1), 72(2) of the dust port 60. In the illustrated embodiment, the respective lower edges 33(2), 34(2) of the inner and outer walls 33, 34, each define a groove 40 that receives a rail 65 defined by a respective one of the dust port upper edges 72(1), 72(2). The groove 40 includes a groove first portion 40(1) that adjoins the blade cover rear wall 36, and a groove second portion 40(2) that extends between the groove first portion 40(1) and the blade cover front wall 35.

The groove first portion 40(1) has a U-shaped cross section when the blade cover 32 is viewed in a direction facing the front or rear walls 35, 36. In addition, the groove first portion 40(1) of the lower edge 33(2) of the inner wall 33 and the groove first portion 40(1) of the lower edge 34(2) of the outer wall 34 open facing each other.

The groove second portion 40(2) has a U-shaped cross section when the blade cover 32 is viewed in a direction facing the front or rear walls 35, 36. However, the U-shape of the groove second portion 40(2) is relatively narrow as compared to the U-shape of the groove first portion, and the groove second portions 40(2) of the respective lower edges 33(2), 34(2) of the inner and outer walls 33, 34 open facing away from the table top second surface 4.

The dust shield 50 is a rigid, thin plate having a rectangular profile when viewed in a direction parallel to the rotation axis 26. The dust shield 50 is suspended from the table top second surface 4 on a side of the blade 14 that is opposed to the undercarriage 10. The dust shield 50 includes a first side 51 that faces toward the blade 14, and an opposed, second side 52 that faces away from the blade 14. The dust shield 50 includes a first planar portion 50(3) that adjoins an upper edge 50(1) of the dust shield 50, and a second planar portion 50(4) that extends between the first planar portion 50(3) and a lower edge 50(2) of the dust shield 50. The first and second planar portions 50(3), 50(4) are obtusely angled with respect to each other.

The dust shield 50 includes through openings 56 disposed closely adjacent to the dust shield upper edge 50(1). In the illustrated embodiment, the dust shield 50 includes two through openings 56 that are spaced apart along the dust shield upper edge 50(1). The through openings 56 receive U-shaped straps 55 that are fixed to the table top second surface 4. The straps 55 permit the dust shield 50 to pivot relative to the table top 2 about an axis that is perpendicular to the rotational axis 26.

The dust shield 50 includes a first flange 53 that extends along a front edge 50(5) of the dust shield 50, and a second flange 54 that extends along a rear edge 50(6) of the dust shield 50. The first and second flanges 53, 54 each protrude toward the undercarriage 10. In use, the first flange 53 overlies at least a portion of the blade cover front wall 35, and the second flange 54 overlies at least a portion of the blade cover rear wall 36.

A pair of springs 58 connect the dust shield 50 to the undercarriage 10. In some embodiments, the springs 58 are coil springs that bias the dust shield 50 toward the blade cover outer wall 34. One of the springs 58 extends between a fastener boss 50(7) disposed adjacent to the dust shield front edge 50(5) and the undercarriage 10. The other spring 58 extends between a fastener boss 50(8) disposed adjacent to the dust shield rear edge 50(6) and the undercarriage 10. In some embodiments, the springs 58 are directly connected to the undercarriage 10. In other embodiments, the springs 58 are indirectly connected to the undercarriage 10, for example via an intermediate structure such as a bracket that itself is connected to the undercarriage 10. As seen in at least FIGS. 1-4, a spring 58 is connected to the undercarriage 10 via a cover plate 46 that is connected to the undercarriage 10, and overlies portions of both the blade cover rear wall 36 and the dust shield second flange 54.

The upper edge 50(1) of the dust shield 50 underlies, and is aligned with, the second portion 5(2) of the blade opening 5. However, due to the biasing effect of the springs 58, the lower edge 50(2) of the dust shield 50 abuts the blade cover outer wall 34. Moreover, the angled first planar portion 50(3) directs cutting debris toward the center of the enclosure 31 and downward toward the dust port 60.

The dust port 60 provides a floor of the enclosure 31 defined by the dust management assembly 30, and is shaped and dimensioned to facilitate evacuation of debris that collects on the floor of the enclosure 31. The dust port 60 includes a tubular portion 62 and a trough portion 72 that protrudes from one end of the tubular portion 62.

The tubular portion 62 is a hollow cylinder having an open first end 63 that is configured to be connected to a dust collection hose (not shown) or dust collection bag (not shown). The tubular portion 62 includes an open second end 64 that is integral with the trough portion 72. A centerline 65 of the tubular portion 62 extends through the tubular portion first and second ends 63, 64. The tubular portion second end 64 includes a flange 66. The flange 66 protrudes from an outer surface of the tubular potion 62 and extends along a portion of the circumference thereof. When viewed in a direction parallel to the tubular portion centerline 65, the periphery 66(1) of the flange 66 has a generally triangular shape. An apex 67 of the flange 66 is diametrically opposed to the lowest extent 76 of the trough portion 72, and includes a through hole that receives a fastener 68. The fastener 68 is used to secure the dust port 60 to the blade cover 32.

The trough portion 72 is a long, shallow, U-shaped receptacle that opens upward so as to face the cutting edge 15 of the blade 14. The trough portion has an open first end 73 that communicates with the tubular portion second end 64, and a closed second end 74 that angled to accommodate the curve of the lower portion 35(4) of the blade cover front wall 35. A centerline 75 of the trough portion 72 extends between the trough portion first and second ends 73, 74 and is substantially parallel to the tubular portion centerline 65 and the undercarriage 10.

The trough portion 72 forms the sliding, detachable connection with the blade cover 32. In particular, the respective upper edges 72(1), 72(2) of the trough portion 72 are parallel to each other and include the rails 65 that are configured to form a slidable engagement with respect to corresponding parallel lower edges 33(2), 34(2) of the inner and outer walls 33, 34 of the blade cover 32. In the illustrated embodiment, the respective upper edges 72(1), 72(2) of the trough portion 72 each define a rail 65 that is received in, and can translate along, a corresponding groove 40 provided on the blade cover lower edges 33(2), 34(2). Each rail 65 includes a rail first portion 65(1) that adjoins the trough portion first end 73, and a rail second portion 65(2) that extends between the rail first portion 65(1) and the trough second end 74.

The rail first portion 65(1) has a U-shaped cross section when the dust port 60 is viewed in a direction facing the front or rear walls 35, 36 (e.g., in a direction parallel to the centerlines 65, 75 of the tubular portion 65 and the trough portion 75). The U-shaped rail first portions 65(1) are constituted by providing an L-shaped flange on an outer surface of the trough portion 72 closely spaced from the trough portion upper edges 72(1), 72(2). By this configuration, the trough portion upper edges 72(1), 72(2) provide a portion of the U-shaped rail first portions 65(1), which each open facing the table top second surface 4. When the dust port 60 is fully assembled with the blade cover 32, each of the first rail portions 65(1) reside within a respective one of the groove first portions 40(1).

The rail second portions 65(2) are constituted by the respective upper edges 72(1), 72(2) of the trough portion 72 (e.g., the L shaped flange is omitted). When the dust port 60 is fully assembled with the blade cover 32, each of the second rail portions 65(2) extend into a respective groove second portion 40(2).

In use, the dust port 60 is connected to the second end 38 of the blade cover 32 by the engagement between the blade cover grooves 40 and the dust port rails 65, and thus closes the blade cover open second end 38. The dust port 60 may be selectively detached from the blade cover 32 by removing the fastener 68, and then sliding the dust port 60 toward the rear of the table saw 1. As a result of the configuration of the grooves 40 and rails 65, the dust port 60 is movable relative to the blade cover 32 within a plane that is parallel to the work surface 3.

As previously discussed, the dust management assembly 30 is disposed on the opposite side of the undercarriage 20 relative to the motor assembly 20. The blade cover 32 is supported relative to the blade 14 by the bracket 42, which extends through the undercarriage opening. By this configuration, the blade cover 32 and the dust port 60 move in concert with the motor assembly 20, and thus also with the blade 14. Although an upper portion of the dust shield 50 is pivotably connected to the table top second surface 4, the dust shield 50 is connected to the blade cover 32 via the springs 58, which bias the dust shield 50 against the blade cover outer wall 34. By this configuration, the dust shield 50 overlies the blade over outer wall 34 regardless of the position of the blade cover 32 and dust port 60 relative to the table top 2. Moreover, by this configuration, the dust management assembly 30 closely encloses portions of the blade 14 disposed below the table top 2.

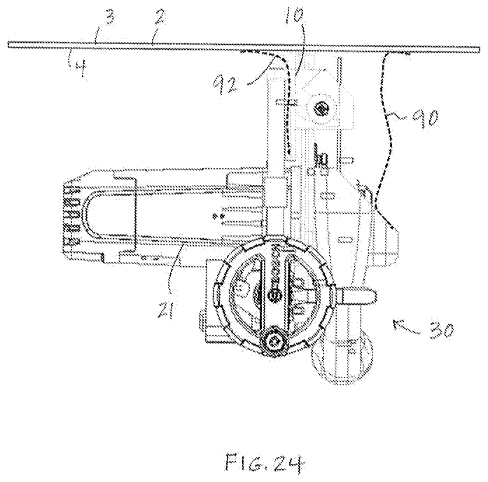

Referring to FIG. 24, although the dust shield 50 is described above as being a rigid, thin plate, the dust shield 50 is not limited to this configuration. In other embodiments, the dust shield 50 may be a flexible sheet material such as a woven fabric, fine mesh or rubber mat. In still other embodiments, the dust shield 50 may include two flexible sheets 90, 92 that are suspended from the table top second surface 4, one sheet on each side of the blade 14.

In the illustrated embodiment, the table saw 1 is cabinet-free and the table top support structure includes a set of legs 8. This configuration is light in weight relative to some cabinet-type support structures and permits easy access to accessories stored below the table top 2. It is understood, however, that in other embodiments of the table saw 1 the table top support structure may be a closed cabinet, or a combination of legs and cabinet elements.

Although the blade cover 32 is described above as having grooves 40 that form a sliding connection with rails 65 provided on the dust port 60, the dust management assembly 30 is not limited to this configuration. For example, in other embodiments, the blade cover 32 may be formed having rails that are received in corresponding grooves provided on the dust port 60. In still other embodiments, the blade cover 32 and dust port 60 may be detachably connected using other types of connections such as, but not limited to, snap fit or press fit connections.

Selective illustrative embodiments of the power tool and dust management assembly are described above in some detail. It should be understood that only structures considered necessary for clarifying the power tool and dust management assembly have been described herein. Other conventional structures, and those of ancillary and auxiliary components of the power tool and dust management assembly, are assumed to be known and understood by those skilled in the art. Moreover, while a working example of the power tool and dust management assembly have been described above, the power tool and dust management assembly are not limited to the working example described above, but various design alterations may be carried out without departing from the power tool and dust management assembly as set forth in the claims.

1. A power tool, comprising:
a table top including
a work surface on a first side of the table top,
a table top second surface on a second side of the table top beneath the first side of the table top, the first and second sides being on opposite sides of the table top, and
a blade opening that extends between the work surface and the table top second surface;
a rigid undercarriage that is supported by the table top beneath the table top second surface;
a motor assembly that includes a motor and is supported by the undercarriage in such a way that the motor assembly is movable, relative to the undercarriage, between a first position and a second position; and
a dust management assembly comprising:
a blade cover that is fixed to the motor assembly and is configured to surround a portion of a blade that is operatively connected to the motor;
a dust shield that is pivotably connected to the table top in such a way that an inner surface portion of an inner wall of the dust shield faces toward an outer wall of the blade cover; and
a dust port that is detachably connected to the blade cover and is configured to collect debris generated by a cutting action of the blade when the blade is operatively connected to the motor,
wherein in at least configuration of the motor assembly
an edge of an inner wall of the blade cover is aligned with the blade opening, and
the inner wall of the dust shield extends downwardly and toward the outer wall of the blade cover from a location that is not directly beneath the blade opening to a location that is directly beneath the blade opening.

2. The power tool of claim 1, wherein the motor and the dust management assembly are disposed on opposite sides of the undercarriage.

3. (canceled)

4. The power tool of claim 1, wherein
the power tool is cabinet-free, and
the dust management assembly serves as a barrier that prevents access to the blade from the second side of the table top when the blade is operatively connected to the motor.

5. The power tool of claim 1, wherein
the undercarriage extends from the table top second surface and has an undercarriage through opening,
a bracket connects the dust management assembly to the motor assembly, and
the bracket extends through the undercarriage through opening.

6. The power tool of claim 1, wherein the dust port is movable relative to the blade cover within a plane that is parallel to the work surface.

7. (canceled)

8. The power tool of claim 1, wherein
the blade cover includes
an open blade cover first end that adjoins the inner wall and faces upwardly, and
an open blade cover second end that adjoins the inner wall and is opposed to the blade cover first end;
the inner wall is configured to be disposed between the blade and the undercarriage when the blade is operatively connected to the motor
the dust shield is configured to be disposed on an opposed side of the blade relative to the blade cover inner wall when the blade is operatively connected to the motor, the dust shield being movable relative to the blade cover; and
the dust port is detachably connected to the blade cover second end.

9. The power tool of claim 1, wherein the dust shield is spring-biased toward the blade cover.

10. The power tool of claim 8, wherein
the dust port includes a tubular portion and a trough portion that protrudes from one end of the tubular portion,
the trough portion includes a first pair of parallel edges that extend in parallel to a longitudinal axis of the tubular portion, and each edge of the first pair of parallel edges is configured to provide one of a rail or a groove,
the blade cover second end includes a second pair of parallel edges, and each edge of the second pair of parallel edges is configured to provide the other of the rail or the groove, and
the first pair of parallel edges are configured to engage with, and translate relative to, the second pair of parallel edges.

11. The power tool of claim 1, wherein
the inner wall is configured to be disposed between the blade and the undercarriage when the blade is operatively connected to the motor, the inner wall being parallel to a first surface of the blade when the blade is operatively connected to the motor, and
the blade cover comprises
an outer wall configured to be disposed on a side of the blade that is opposite the undercarriage when the blade is operatively connected to the motor, the outer wall being angled relative to the inner wall.

12. The power tool of claim 11, wherein
the blade cover comprises
a first side wall configured to be disposed on a side of the blade corresponding to a cutting edge of the blade when the blade is operatively connected to the motor, the first side wall extending between the inner wall and the outer wall, and
a second side wall that extends between the inner wall and the outer wall, the second side wall configured to be disposed on an opposite side of the blade relative to the first side wall when the blade is operatively connected to the motor,
wherein the second sidewall has a curved portion that is shaped to correspond to a curved periphery of the blade.

13. The power tool of claim 1, wherein
the inner wall of the blade cover and the outer wall of the blade cover are parts gf a wall configured to partially encircle a portion of the blade when the blade is operatively connected to the motor, the wall further including
an open first end that faces toward the table top second surface, and
an open second end that is opposed to the first end and forms a connection with the dust port,
and wherein when viewed in a direction perpendicular to a rotational axis of the blade when the blade is operatively connected to the motor, a dimension of the first end is greater than a dimension of the second end.

14. The power tool of claim 1, wherein the dust shield overlies a gap that is disposed between the blade cover and the table top second surface.

15. The power tool of claim 1, wherein the dust management assembly is configured to form an enclosure around the blade when the blade is operatively connected to the motor and includes a declining curved surface configured to direct debris to the dust port.

16. A power tool, comprising:
a table top including
a work surface that defines a first side of the table top,
a table top second surface that defines a second side of the table top beneath the first side of the table top, the first and second sides being on opposite sides of the table top, and
a blade opening that extends between the work surface and the table top second surface;
a rigid undercarriage that is supported by the table top beneath the table top second surface;
a motor assembly that includes a motor and is supported by the undercarriage in such a way that the motor assembly is movable relative to the undercarriage between a first position and a second position;
and
a dust management assembly that is disposed on an opposed side of the undercarriage relative to the motor, the dust management assembly comprising:
a blade cover that is secured to the motor assembly, the blade cover including a sidewall configured to partially encircle a portion of a blade operatively connected to the motor whereby a portion of the sidewall is disposed between the blade and the undercarriage, the sidewall defining an open blade cover first end that faces upwardly, and an open blade cover second end that is opposed to the blade cover first end;
a dust shield that is pivotably connected to the table top in such a way that an inner surface portion of an inner wall of the dust shield faces toward an outer wall of the blade cover sidewall; and
a dust port that is detachably connected to the blade cover second end, the dust port including a U-shaped trough portion that is configured to be connected to the blade cover, and a tubular portion that protrudes from one end of the trough portion,
wherein
the trough portion includes a first pair of parallel edges that extend in parallel to a longitudinal axis of the curved portion, and each edge of the first pair of parallel edges is configured to provide one of a rail or a groove,
the blade cover second end comprises a second pair of parallel edges, each edge of the second pair of parallel edges is configured to the other of the rail or the groove,
the first pair of parallel edges are configured to engage with, and translate relative to, the second pair of parallel edges,
an edge of an inner wall of the blade cover sidewall is aligned with the blade opening in at least configuration of the motor assembly, and
the inner wall of the dust shield extends downwardly and toward the outer wall of the blade cover from a location that is not directly beneath the blade opening to a location that is directly beneath the blade opening in the at least configuration of the motor assembly.

17. (canceled)

18. The power tool of claim 17, wherein
the dust shield is movable relative to the blade cover, and
the dust shield is spring-biased toward the blade cover.

19. The power tool of claim 16, wherein:
the inner wall is configured to be disposed between the blade and the undercarriage when the blade is operatively connected to the motor, the inner wall being parallel to a first surface of the blade; and
the outer wall is configured to be disposed on a side of the blade that is opposite the undercarriage when the blade is operatively connected to the motor, the outer wall being angled relative to the inner wall.

20. The power tool of claim 16, wherein the dust management assembly forms an enclosure around the blade when the blade is operatively connected to the motor and includes a declining curved surface that directs debris to the dust port.
